(19) United States
(12) Patent Application Publication
(10) Pub. No.: US 2010/0306114 A1
(43) Pub. Date: Dec. 2, 2010

(54) HOUSEHOLD DIGITAL DESCRIPTION DEFINITION (H3D) ARCHITECTURE AND METHOD

(75) Inventors: William K. Bodin, Austin, TX (US); David K. Clark, Cedar Park, TX (US); David Salinas, Pflugerville, TX (US); Theodore J. Shrader, Austin, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/472,453

(22) Filed: May 27, 2009

(51) Int. Cl. G06Q 30/00; G06Q 10/00; G06Q 50/00

(52) U.S. Cl. 705/80; 705/27; 705/10

(57) ABSTRACT

A computer-implemented method, apparatus, and computer program code for conducting a transaction between a merchant and a user. Using a composite key generated by a user, a user profile associated with the user and generated by the user is accessed. Accessing is performed by a merchant. The user profile comprises data specifying a set of household items owned by the user. The user profile is one of a set of user profiles that make up a H3D definition. The H3D definition comprises data describing a plurality of household items belonging to the user. The plurality of household items includes the set of household items. Responsive to accessing the user profile, a merchant profile is generated. The merchant profile comprises data specifying a portion of inventory associated with the merchant. The portion of inventory is selected based on the user profile. An offer to sell the portion of inventory is transmitted.

### BACKGROUND

1. Field

The present invention relates generally to an improved data processing system and in particular to improved devices and methods for conducting transactions. Still more particularly, the present invention relates to maintaining and using a household digital description definition architecture.

2. Description of the Related Art

Often homeowners desire to obtain or replace items contained within their residence. In the past, whenever a homeowner desired to obtain or replace household items, the homeowner would physically go to a merchant's place of business, and either from memory or through the use of paper and pen, present information to a merchant regarding what items the homeowner desired to obtain or replace. Alternatively, the homeowner would make decisions with input from the merchant.

However, these methods for obtaining and replacing household items are inefficient. For example, a homeowner may forget that the homeowner owns certain items that would be relevant to a merchant's recommendation to purchase particular household items. Additionally, a homeowner may not be cognizant of technical issues that would influence a merchant's recommendation for a purchase.

### SUMMARY

The illustrative embodiments described herein provide a computer-implemented method, apparatus, and computer usable program code for conducting a transaction between a merchant and a user. A composite key associated with the user is received. Using the composite key, a profile associated with the user is accessed. The profile comprises data specifying a set of household items associated with the user. The profile is received. Responsive to receiving the profile, a merchant profile is generated. The merchant profile comprises data specifying a portion of inventory associated with the merchant. The portion of inventory is selected based on the profile. The portion of inventory is then offered for sale to the user.

### BRIEF DESCRIPTION OF THE SEVERAL VIEWS OF THE DRAWINGS

The novel features believed characteristic of the illustrative embodiments are set forth in the appended claims. The illustrative embodiments, themselves, as well as a preferred mode of use, further objectives, and advantages thereof, will best be understood by reference to the following detailed description of an illustrative embodiment when read in conjunction with the accompanying drawings, wherein:

FIG. 1 is a block diagram of a network of data processing systems, in which the illustrative embodiments of the present invention may be implemented;

FIG. 2 is a block diagram of a data processing system in which the illustrative embodiments of the present invention may be implemented;

FIG. 3 is an illustration of how household items can be described in an inventory format, in accordance with an illustrative embodiment of the present invention;

FIG. 4 is a block diagram illustrating a household digital description definition (H3D) framework, in accordance with an illustrative embodiment of the present invention;

FIG. 5 is a block diagram illustrating a method of using a household digital description definition to conduct a transaction with a merchant, in accordance with an illustrative embodiment of the present invention;

FIG. 6 is a flowchart describing a process of using a household digital description definition to perform a transaction with a merchant, in accordance with an illustrative embodiment of the present invention;

FIG. 7 is a flowchart of a process for generating a household digital description definition, in accordance with an illustrative embodiment of the present invention;

FIG. 8 is a flowchart of a process for updating a household digital description definition, in accordance with an illustrative embodiment of the present invention;

FIG. 9 is a flowchart illustrating a process of setting levels of information and security for profiles within a household digital description definition, in accordance with an illustrative embodiment of the present invention;

FIG. 10 is a flowchart illustrating a process of establishing privacy levels for profiles, in accordance with an illustrative embodiment of the present invention;

FIG. 11 is a flowchart of a process for establishing a security level for a Web service profile, in accordance with an illustrative embodiment of the present invention;

FIG. 12 is a flowchart illustrating a process of updating a household digital description definition, in accordance with an illustrative embodiment of the present invention;

FIG. 13 is a flowchart illustrating a process of using a household digital description definition to conduct a transaction with a merchant, in accordance with an illustrative embodiment of the present invention;

FIG. 14 is a flowchart of a process for conducting a transaction between a merchant and a user using a profile of a household digital description definition, in accordance with an illustrative embodiment of the present invention; and

FIG. 15 shows exemplary pseudo code for defining a household digital description definition, in accordance with an illustrative embodiment of the present invention.

### DETAILED DESCRIPTION

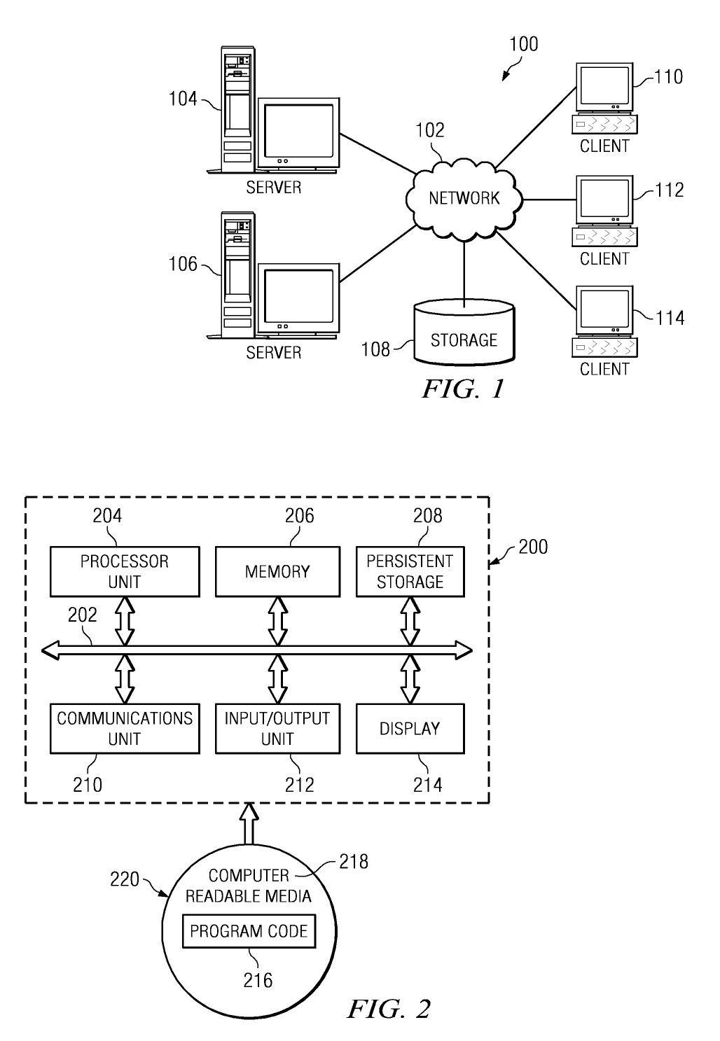

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a block diagram of a network of data processing systems, in which the illustrative embodiments of the present invention may be implemented. Network data processing system 100 is a network of computers in which the illustrative embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is a block diagram of a data processing system in which the illustrative embodiments of the present invention may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments described herein provide a computer-implemented method, apparatus, and computer usable program code for conducting a transaction between a merchant and a user. A composite key associated with the user is received. Using the composite key, a profile associated with the user is accessed. The profile comprises data specifying a set of household items associated with the user. The term “associated with” can include “owed by.” The profile is received. Responsive to receiving the profile, a merchant profile is generated. The merchant profile comprises data specifying a portion of inventory associated with the merchant. The portion of inventory is selected based on the profile. The portion of inventory is then offered for sale to the user.

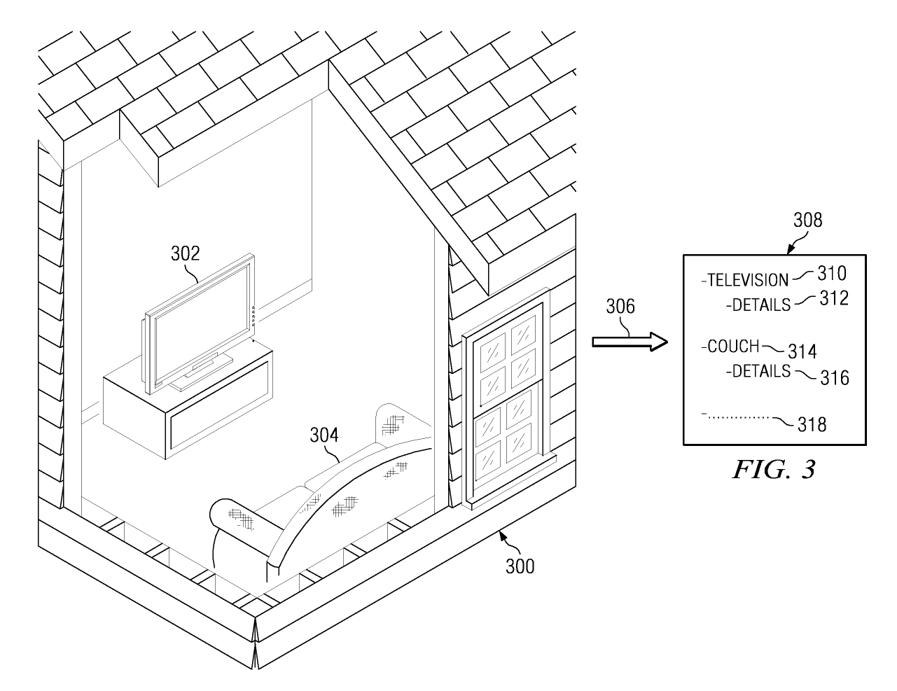

FIG. 3 is an illustration of how household items can be described in an inventory format, in accordance with an illustrative embodiment of the present invention. The inventory description shown in FIG. 3 can be implemented in a data processing system such as server 104, server 106 or client 110, client 112, or client 114 in FIG. 1, or data processing system 200 shown in FIG. 2.

In the example shown in FIG. 3, house 300 includes a number of household items such as, for example, television 302 and couch 304. As shown by arrow 306, these items could be presented in an inventory stored in a data processing system. For example, inventory 308 contains entries for television 302 at line 310. Line 312 shows various details regarding television 302, and can be associated with the entry for the television. These details can include the model number, manufacturer serial number, and television characteristics such as, number and type of connections, screen size, light output, or many other possible facts regarding television 302.

Similarly, line 314 provides an entry for couch 304. Likewise, line 316 shows that various details about couch 304 can be associated with line 314. The details regarding the couch can include the type of couch, model of couch, size of couch, or possibly many other details regarding couch 304. Line 318 shows that many other entries can be included in inventory 308 for various other household items. Household items that can be included in inventory 308 include, but are not limited to, a television, a video cassette recorder, a digital video recorder, a radio, a stereo, a refrigerator, a washing machine, a dryer, a dishwasher, a mobile phone, a camera, a toaster, a wireless picture frame, a clock, an article of furniture, an article of kitchen equipment, a book, a telephone, food items, an article of clothing, a switch, a lamp, a water heater, an air conditioner, a heater, a fireplace, a pet, any other object living or inanimate, and combinations thereof.

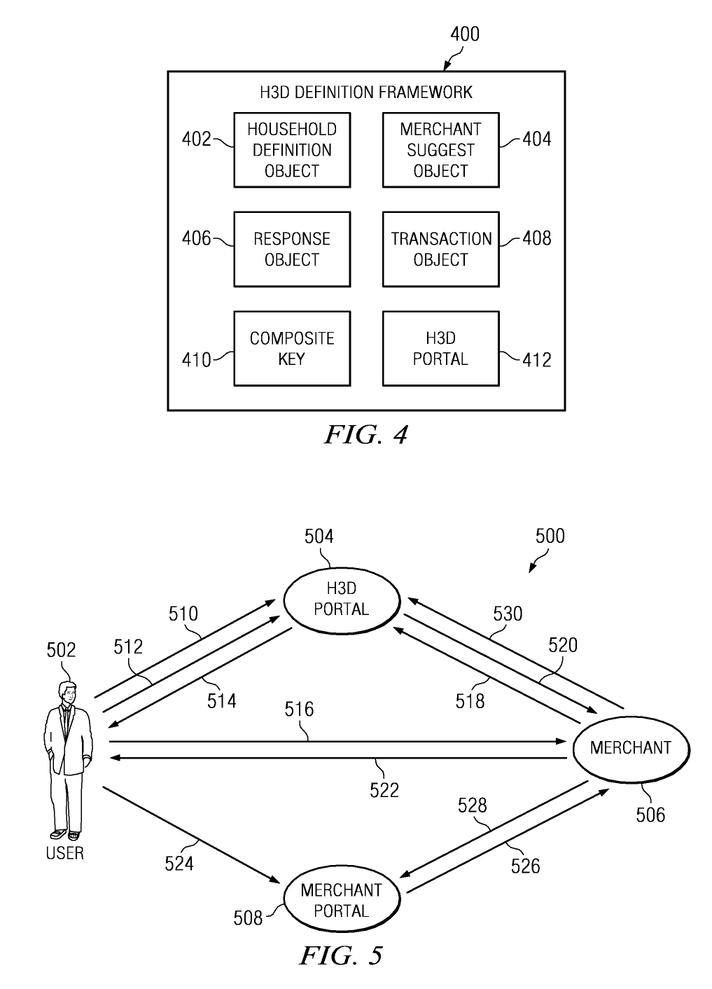

FIG. 4 is a block diagram illustrating a household digital description definition (H3D) framework, in accordance with an illustrative embodiment of the present invention. Household digital description definition (H3D) 400 defines a framework for storing an inventory of household items, such as inventory 308 in FIG. 3. Household digital description definition 400 can be implemented in a data processing system, such as server 104, server 106 or client 110, client 112, or client 114 in FIG. 1, or data processing system 200 shown in FIG. 2.

The illustrative embodiments described herein enable an electronic description of a user's household, and an architectural definition for distribution of selected information contained in the household digital description definition. Some or all of the contents of the household digital description definition can be distributed in a standardized format, such as in an extensible markup language (XML) or other markup language. The characteristics that can be included in the household digital description definition can include blueprints and layouts of furniture in various rooms, lists of household items, physical and technical objects in the house, controls for managing electrical and gas uses in the house, and other descriptions and information. The household digital description definition can also include demographic descriptions and preferences of people, pets, and plants associated with the house.

When shopping for a household item, the user can provide the vendor access to public or authorized sections of the household digital description definition file. If the vendor desires information that is protected as private in the household digital description definition file, the user can give access to just those desired sections.

Household items can be conveniently added or removed from the users household digital description definition file. Household items can be identified via various methods including, but not limited to, the use of radio frequency identification tags. Manufacturing numbers, model numbers, serial numbers, and other information can be imbedded in the radio frequency identification tags. Bar codes and a bar code scanner can also be used to identify items and store item information in the household digital description definition. Additionally, other methods may include the scanning of devices and items through wireless connectivity to the household's Internet and/or crawling through the local area network to identify connected devices or items.

Additionally, such information can be transmitted via the Internet in the form of an equipment identifier tag (EIT). An equipment identifier tag can subsequently be used to obtain detailed information on specific items. For example, via the Internet, information can be obtained such as dimension materials, electrical specifications, user installation manuals, service and repair information, and other information.

The radio frequency identification tags, equipment identifier tags, bar codes, and other identifiers act as unique identifiers to allow users to obtain data from manufacturers to be incorporated in the household digital description definition file.

Security can be maintained at different levels for different parts of the household digital description definition file. For example, portions of the file can be designated as freely available to anyone. In other words, the public can access portions of the file through network connections, such as the Internet. Selected portions of the household digital description definition file can also be arranged as partially public such as, for example, including public consumer contact information or information regarding the user without revealing the identity of the user. Selected portions, or all, of the household digital description definition can also be designated as private, meaning that such information is available only to specific persons, groups of persons, or to those users that have the appropriate authentication.

Once household digital description definition data from various objects populate a file, the user can further customize the data. For example, the user can input information that describes modifications to purchased items. Subsets of the household digital description definition data can be identified because these subsets of modified data would not match the signature of the manufacturer-supplied official data. This modified subset of data alerts any recipient of the consumer's modifications.

Returning to the illustrative example of FIG. 4, household digital description definition framework 400 includes a number of objects. In the illustrative embodiments, transactions can be processed by passing data between entities using these objects. Using these objects provides symmetry that allows transactions to be processed between the various objects associated with a particular household digital description definition framework and frameworks or objects maintained by merchants or other entities.

In the illustrative example shown in FIG. 4, household definition object 402 is a complete representation of the user's inventory, though household definition object 402 can represent a subset of the user's inventory. Household definition object 402 can be referred to as a real household digital description definition, as household definition object 402 defines the description of the user's dwelling and contents. The user's real household digital description definition can be updated by merging other household digital description definitions, as described below, via a nightly scan of the house or by other means of defining and verifying the contents of the household and location of items within the household.

Merchant suggest object 404 is an object returned by a merchant. Merchant suggest object 404 is compatible with household definition object 402 and with household digital description definition framework 400. Merchant suggest object 404 can provide a list of suggested items that the user may be interested in acquiring. For example, if the user is looking for a DVD player, the retailer can return a merchant suggest object 404 that contains one or more DVD players that would fit and work properly within the user's real household digital description definition. Thus, if the user purchases a DVD player listed in merchant suggest object 404, then that DVD player is more likely to be compatible with a television or other electronic equipment with which the DVD player would be used. In an illustrative example, the user can combine his real household digital description definition and merchant suggest object 404, and then display the result to view how the possible objects would look in the user's household in a three dimensional rendering environment.

Response object 406 is the object used to send a response from the user to the merchant. When the user selects items from merchant suggest object 404, the selected items are returned to the merchant in the form of response object 406. Response object 406 indicates items in merchant suggest object 404 in which the user is or is not interested. The merchant can use response object 404 to complete the user's transaction, to further refine the list of possibilities for purchase, or to perform other actions. In reply to response object 406, the merchant can transmit another merchant suggest object 404, or can complete the transaction if no further input is desired by the user.

Transaction object 408 is an object transmitted by the merchant to the user's household digital description definition framework. Transaction object 408 can merge with household definition object 402 in order to create an updated household definition object. Transaction object 408 may first be merged in a temporary state, allowing the user to perform additional shopping or to conduct transactions with additional retailers. Once the user has physically installed the purchased items, the user can approve transaction object 408 to be merged into household definition object 402. In this way, household definition object can be updated.

Composite keys 410 can be used to identify profiles within the household digital description definition framework. A profile can be used to specify certain groups of information such as, for example, all video electronic devices. Thus, when the user desires to purchase a new video electronic device, the profile associated with just those video electronic devices can be associated with composite key 410. The user can then allow a merchant to access only that specific profile via the use of composite key 410.

In addition, household digital description definition portal 412 is a means that can be used to access the household digital description definition framework 400. Household digital description definition portal 412 can be a Web service portal through which the user and/or merchants can interact with household digital description definition framework 400.

The illustrative embodiments of the present invention can also be used with respect to online stores. The illustrative embodiments of the present invention are particularly well suited to online stores and online shopping, because the exchange of objects, such as those shown in FIG. 4, can be performed automatically as the user is shopping online. If preferred, a user can be given control over whether to allow certain objects to be received or accepted with respect to household digital description definition framework 400. For example, a profile can still be generated by the user, and a user can determine when to allow transaction object 408 to be merged with household definition object 402. Alternatively, a profile can be generated automatically in response to merchant suggest object 404. Thus, the illustrative embodiments of the present invention can provide for enhanced online shopping.

FIG. 5 is a block diagram illustrating a method of using a household digital description definition to conduct a transaction with a merchant, in accordance with an illustrative embodiment of the present invention. The process shown in FIG. 5 can be implemented in a data processing system, such as server 104, server 106 or client 110, client 112, or client 114 in FIG. 1, or data processing system 200 shown in FIG. 2. The process shown in FIG. 5 can be implemented over a network, such as network 102 shown in FIG. 1. The process shown in FIG. 5 can be implemented using a household digital description definition framework 400 shown in FIG. 4.

Process 500 includes four primary actors, including user 502, H3D portal 504, merchant 506, and merchant portal 508. User 502 is associated with a real H3D file corresponding to a household definition object, such as household definition object 402 in FIG. 4. The real H3D file contains a description of the household items of user 502. The real H3D file can be accessed via H3D portal 504 using a personalized H3D composite key as shown by arrow 510.

User 502 initially creates a personalized H3D composite key that can be used to refer a particular profile as shown by arrow 512. A particular profile reflects items contained in a particular area of a house, or can represent items of a particular type. For example, a profile can reflect those items that are contained in a user's living room or, alternatively, all cameras belonging to the user. A profile can represent a combination of parameters, such as all cameras in a user's living room. The composite key is specially created for the merchant. Other vendors may have different keys that access different sections of the user's real H3D definition.

After creating the composite key, H3D portal 504 returns the H3D composite key to user 502 as shown by arrow 514. This key can be stored in a mobile computing device carried by user 502. A mobile computing device can be a portable computer, cellular phone, a mobile communication device, a smart card, a memory stick, or any other form of data storage or data processing.

In this illustrative example, user 502 desires to purchase an electronic item that will be compatible with his existing set of electronic items and that will function as desired with his existing set of electronic items. In this illustrative example, user 502 enters a physical electronics store. Upon entering the store, user 502 uses the mobile computing device to provide the composite key to the merchant as shown by arrows 516. User 502 can provide merchant 506 with a composite key via a kiosk input area, or by an automatic wireless scan performed by merchant 506. User 502 also can provide merchant 506 with a description of a desired item at this point.

Next, the merchant accesses the H3D portal 504 using the generated composite key, as shown by arrow 518. The merchant then receives the H3D profile associated with the composite key as shown by arrow 520. The merchant then matches the user's H3D profile to the merchant's existing inventory and customizes a suggest H3D object such as, for example, merchant suggest object 404 in FIG. 4. Merchant 506 then returns a merchant composite key that is unique to the store and to the user with respect to the user's profile obtained from H3D portal 504. This transaction is shown by arrow 522.

Using the mobile computing device, or some other means provided by merchant 506, user 502 then accesses merchant portal 508 using the merchant composite key, as shown by arrow 524. In an illustrative example, a graphical interface or some other interface could be used to suggest items for purchase by user 502. For example, a monitor could display various types of DVD players to user 502, from which user 502 could select. In another illustrative example, a three dimensional image of the DVD player can be placed in a virtual representation of the user's living room and then displayed to user 502.

User 502 then makes a selection from the electronic store's catalogue and, based on the selection, merchant portal 508 will create a response object such as, for example, response object 406 in FIG. 4, that is sent to merchant 506. The response object acts like a virtual shopping cart. This transaction is shown by arrow 526.

If the user has not made a final selection, the merchant may make additional recommendations such as, for example, speakers that the user may not have in his household, but that would be compatible with the DVD player in which the user is interested. This additional suggestion is represented by arrow 528. A merchant can also offer user 502 special pricing that is based specifically on the user's profile obtained from H3D portal 504. Similarly, the profile can be used to create bundles of products to be offered for sale to user 502. This cycle of transactions, represented by arrow 526 and arrow 528, continues until the user makes a final purchase.

After the final purchase, the merchant 506 creates a transaction object such as, for example, transaction object 408 in FIG. 4, that contains the purchased electronic items that the user has not yet physically added to the user's household. Merchant 506 then sends the transaction object to H3D portal 504 as shown by arrow 530. The user can cause the items in the transaction object to be added to the household digital description definition object once the items have been physically installed in the user's household. At that time, the items in the transaction object are added to the real H3D definition.

In an illustrative example, a merchant suggest object, such as merchant suggest object 404 in FIG. 4, can also represent a virtual wish list of items that the user would like to have added to the household, but that do not already physically exist in the household. The composite key accessing the wish list suggest object can be shared with other family members, such as for a wedding registry.

Because the unique composite key, not the wish list object, is shared, the suggest object stored on the H3D portal server can always be updated as purchases are made and transaction objects are created. This system ensures that whenever the wish list is accessed, the recipient can always receive the latest wish list suggest object.

When the actual gift is delivered to the user the transaction object for the gift would accompany it, and both could be incorporated into the user's household, physically and electronically. The household digital description definition file would then be updated appropriately.

In another illustrative example, in addition to the physical description of the existing room, the user may allow access to income information and other demographic information which would allow a salesperson to eliminate or include items that are suitable for that particular demographic. For example, if the user had sufficient income, then the salesperson may present premium items to the user. Likewise, a salesperson can exclude expensive items from the offerings, if the user is unlikely to desire to spend the amount of money needed to purchase the expensive items.

In another illustrative example, the system described in FIG. 5 can be used with respect to obtaining services in addition to obtaining physical items. For example, the user may have a problem with an appliance in the home. In this case, the user can identify a vendor to provide repair service to contact the service provider, provide details about the appliance, and then make an appointment for the service call. In this case, a household digital description definition profile can be used to provide information about the appliance, including a favorite service provider or any warranty or contract for ongoing service. An Internet connection may also be used to locate and/or contact a local service repair man.

In another illustrative example, the household digital description definition framework can be used to operate a household. For example, the household digital description definition framework can be used to describe electrical equipment, such as heaters, air conditioners, or other energy intensive devices such as water heaters, pumps, refrigerators, or freezers. Via the household digital description definition framework, the user could define certain equipment for automated control by other software that provides for time-based control of input power in order to limit or conserve energy. Control of these devices could also be timed for particular events such as, for example, when the user is planning on arriving home or leaving from home, or when the user activates one or more buttons or switches on a remote control. This same system can also be defined to provide permission to the electronic devices to shut down selected equipment in the event a brown-out or phase power restart in order to reduce wide spread surges on power restart.

In another illustrative embodiment, the household digital description definition framework can include descriptions of people and pets. Thus, the framework can be used to find medical services or other personal services for the individuals that live in the household, or to provide products or services for the pets that dwell within the household.

In the case that the household digital description definition is part of a community network of digital descriptions, additional data elements from the household digital description definition framework could be used. For example, a definition of pets would allow pet finders to locate the owner of a lost pet, or for firefighters to be aware a pet is inside a household during a fire. Similarly, such community of networks could be used to identify products or services that are available within a local community or to find friends that might share particular interests.

The illustrative embodiments described herein also provide for mechanisms for implementing security and privacy architectures that assure the user of privacy and security. For example, different levels of privacy can be associated with different profiles within a household digital description definition framework. For example, personal profiles associated with the persons and pets living within the household could have a high security level. In this case, passwords or other authentication information would have to be provided via the H3D portal in order to access information described in the profiles. Public information could also be provided, such as for example, a user set of electronic devices. Merchants could access public profiles in order to advertise particular products to the user.

Thus, the illustrative embodiments provide for a mechanism for representing household content data, including the content's characteristics. Associations between various profiles and particular content in the household can be formed. Composite keys can be created for individual profiles. These composite keys can have a predetermined expiration date to increase security.

The composite keys can be used by merchants or others to access various profiles via an H3D portal. These profiles can be accessed by merchants to suggest items for purchase by the user. The suggestions are based on the profile. After the user makes a selection, the user's household digital description definition can be updated based on the purchases made. As a user continues to make purchases, the merchant can continue to provide updated offers or suggestions to the user.

Although the illustrative embodiments have been described with respect to personal households, the illustrative embodiments can also be used with respect to business entities. For example, a business can maintain a digital description definition of the businesses' inventory or goods, such as office supplies and office furniture. A business could be presented with offers for additional, different, or updated business supplies or office furniture, based on profiles maintained by the business in the businesses' digital description definition.

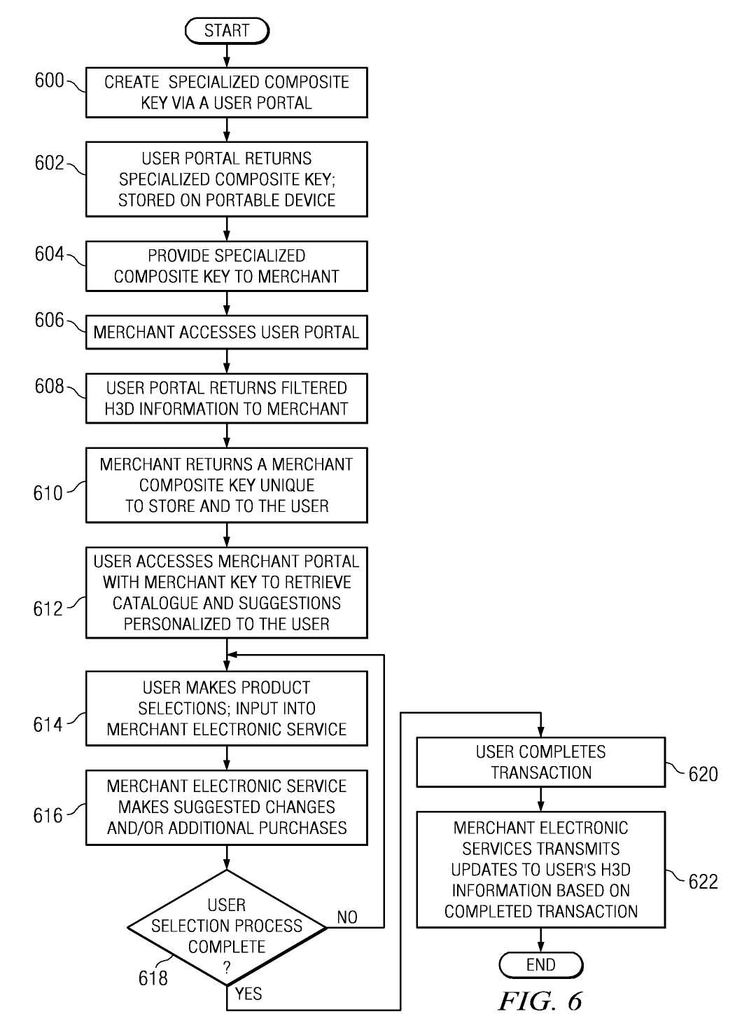

FIG. 6 is a flowchart describing a process of using a household digital description definition to perform a transaction with a merchant, in accordance with an illustrative embodiment of the present invention. The process shown in FIG. 6 can be implemented in a data processing system, such as server 104 or server 106, or client 110, client 112, or client 114 in FIG. 1, or data processing system 200 shown in FIG. 2. The process shown in FIG. 6 is an illustrative example of the process described with respect to FIG. 5. The process shown in FIG. 6 can be implemented using a household digital description definition framework.

The process begins as a user creates a specialized composite key via a user portal (step 600). The specialized composite key is associated with a particular profile. The particular profile represents a subset of information contained within the household digital description definition. Next, the user portal returns the specialized composite key, which is stored on a portable computing device (step 602).

The user then provides the specialized composite key to a merchant (step 604). Using the specialized composite key, the merchant accesses the user portal (step 606). In turn, the user portal returns filtered H3D information to the merchant (step 608). The filtered information is that information contained within the profile. The profile can contain various levels of information that can be accessed at various levels of security.

The merchant then returns a merchant composite key that is unique to the store and to the user (step 610). The user accesses the merchant portal with the merchant key in order to retrieve a catalogue and suggestions personalized to the user (step 612). The user then makes product selections by inputting the selections into a merchant electronic service (step 614). These selections can be made via a network connection using the mobile computing device, or can be made using a kiosk at the merchant's place of business or via input from a salesperson associated with the merchant. The merchant electronic service can be a Web service or software program that manages sales, selections, and offerings.

The merchant's electronic service then makes suggested changes and/or recommends additional purchases (step 616). The merchant portal then determines whether the user selection process is complete (step 618). If the user selection process is not complete (a no determination to step 618) then process returns to step 614 and repeats. Otherwise, (a yes determination to step 618) the user completes the transaction (step 620). The merchant's electronic service then transmits updates to the user's household digital description definition information based on the completed transaction (step 622). The process terminates thereafter.

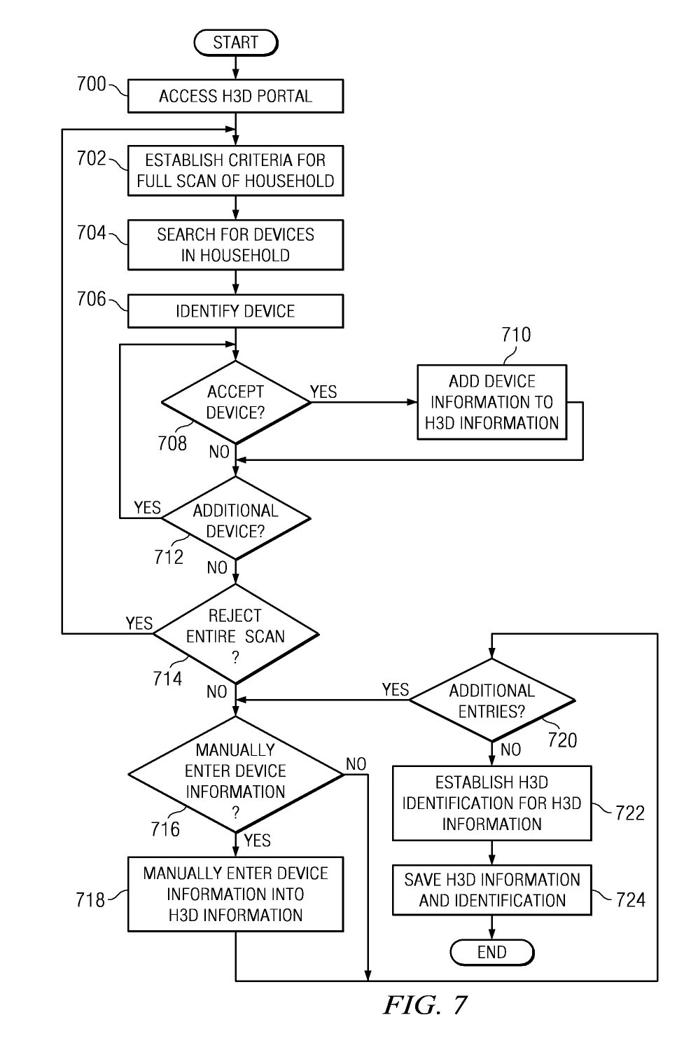

FIG. 7 is a flowchart of a process for generating a household digital description definition, in accordance with an illustrative embodiment of the present invention. The process shown in FIG. 7 can be implemented in a data processing system, such as server 104 or server 106, or client 110, client 112, or client 114 in FIG. 1, or data processing system 200 shown in FIG. 2. In particular, the process shown in FIG. 7 can be implemented using elements shown in FIG. 4 and FIG. 5. The process shown in FIG. 7 can be implemented using a household digital description definition framework.

The process begins as a user accesses the user's H3D portal (step 700). An authentication, such as a password, can be used to provide security for access to the H3D portal. The user then establishes criteria for a full scan of a household (step 702). The criteria can be any set of criteria such as, for example, to search for all items, to search for a particular type of item, to search for a particular type of signal such as, for example a wireless signal, a direct Internet connection, or a radio frequency identification tag signal.

After establishing these criteria, the household digital description definition searches for devices in households (step 704). This scan can be performed through connectivity of wireless Internet, wired Internet, radio frequency identification tags, and broadband over power lines. During this scan, the household digital description definition identifies a device (step 706).

The household digital description definition then determines whether the device has been accepted (step 708). The device is accepted if the device meets preset criteria, or if the user manually accepts the device for inclusion in the definition. If the device is accepted (a yes determination to step 708), then device information is added to the household digital description definition (step 710). Thereafter, or as a result of a no determination at step 708, the household digital description definition framework determines whether or not an addition device has been found (step 712). If an additional device has been found (a yes determination to step 712), then the process returns to step 708 and repeats. Otherwise (a no determination to step 712), the household digital description definition framework determines whether to reject the entire scan (step 714). An entire scan can be rejected by the user for reasons such as, the user noting that certain items or classes of items were not found, which may prompt the user to check for connectivity or the presence of the desired radio frequency identification tags. If the user decides to reject the entire scan, or if the entire scan is rejected automatically for whatever reason (a yes determination to step 714) then the process returns to step 702 and repeats. Otherwise (a no determination to step 714), the household digital description definition framework determines whether to receive manually entered device information (step 716). In this case, a user may wish to manually input product information regarding various products into the household digital description definition. In the event of a yes determination to step 716, the manually entered device information is received into the household digital description definition (step 718). The household digital description definition framework then determines whether to receive additional manual entries (step 720). If additional manual entries are to be received (a yes determination to step 720), then the process returns to step 716 and repeats. Otherwise (a no determination to step 720), the household digital description definition framework establishes the H3D identification for the H3D information generated (step 722). The identification can be a string of alpha-numeric characters, and could be as simple as, for example, a street address for the household. The H3D identification information is analogous to a Service Set Identifier (SSID) for wireless routers. In any case, the H3D information and identification are saved (step 724). The process terminates thereafter.

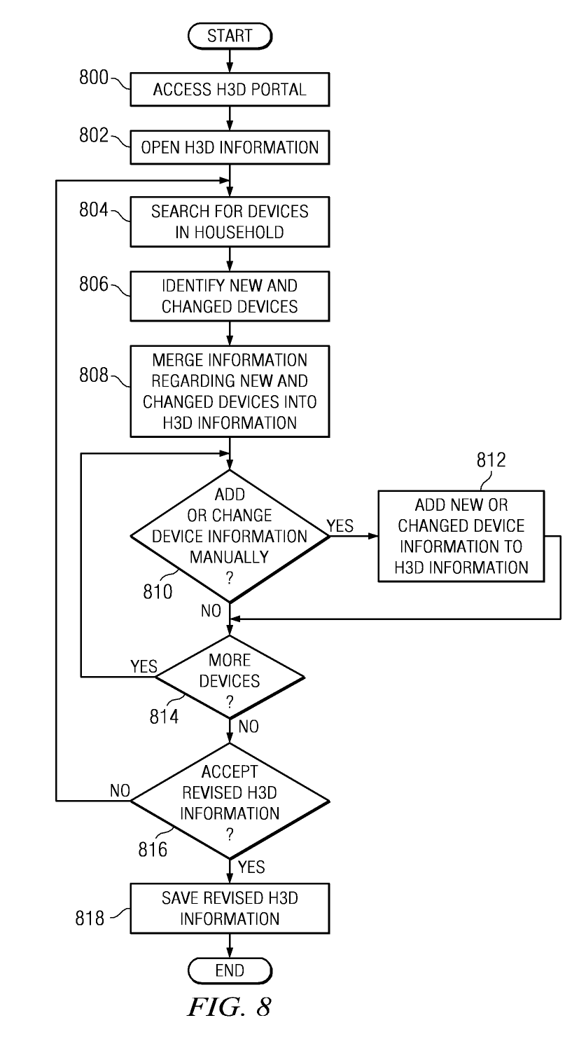

FIG. 8 is a flowchart of a process for updating a household digital description definition, in accordance with an illustrative embodiment of the present invention. The process shown in FIG. 8 can be implemented in a data processing system, such as server 104 or server 106, or client 110, client 112, or client 114 in FIG. 1, or data processing system 200 shown in FIG. 2. The process shown in FIG. 8 can be implemented using the methods and devices described with respect to FIG. 4 and FIG. 5. The process shown in FIG. 8 can be implemented using a household digital description definition framework.

The process begins as a user accesses the H3D portal (step 800). The user then opens the H3D information (step 802). The household digital description definition framework then searches for devices in the household (step 804). The household digital description definition framework then identifies new and changed devices (step 806). Information regarding the new and changed devices is merged into the household digital description definition information (step 808). The household digital description definition framework then determines whether to add or change device information manually (step 810). Such information can be changed manually by receiving the user's input. In response to a yes determination at step 810, the household digital description definition framework adds or changes the device information to the H3D definition (step 812). Then, or in response to a no determination at step 810, the household digital description definition framework determines whether more devices are to be added or changed manually (step 814). In response to a yes determination to step 814 the process returns to step 810 and repeats.

Otherwise, in response to a no determination at step 814, the household digital description definition framework determines whether to accept the revised H3D information (step 816). The revised H3D information can be accepted automatically based on predetermined criteria, or user input can be required to accept a revised set of H3D information. In response to a no determination at step 816, the process returns to step 804 and repeats. Otherwise, in response to a yes determination at step 816, the revised H3D information is saved (step 818). The process terminates thereafter.

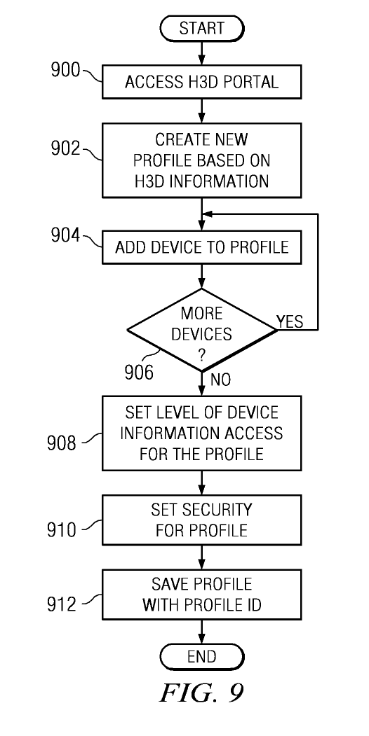

FIG. 9 is a flowchart illustrating a process of setting levels of information and security for profiles within a household digital description definition, in accordance with an illustrative embodiment of the present invention. The process shown in FIG. 9 can be implemented in a data processing system, such as server 104 or server 106, or client 110, client 112, or client 114 in FIG. 1, or data processing system 200 shown in FIG. 2. The process shown in FIG. 9 can be implemented using the methods and devices described with respect to FIG. 4 and FIG. 5. The process shown in FIG. 9 can be implemented using a household digital description definition framework.

The process begins as a user accesses the H3D portal (step 900). The user then creates a new profile based on H3D information (step 902). The user then adds a device to the profile (step 904). The user then determines whether to add more devices to the profile (step 906). The household digital description definition framework can automatically determine whether to add more devices based on predetermined criteria. In response to a yes determination at step 906, the process returns to step 904 and repeats.

Otherwise, in response to a no determination at step 906, the user sets a level of device information access for the profile (step 908). A level of device information access refers to how much information is stored for a particular device in a particular profile. At a very basic level of information, a product type might be identified such as, for example, a television. At a second level of information, a product model number might be identified. At a third level of information, a product serial number might be identified. At one or more of these levels, or at other levels of information, other information regarding a device can be provided, such as a color of device, or various operating parameters of the device.

The user then sets a security level for the profile (step 910). The household digital description definition framework can also set the security for the profile. Security for the profile can be passwords or encryption, or other methods for securing data. Different security levels can be provided for different levels of information within a particular profile. In any case, the household digital description definition framework saves the profile and associates the profile with an identification (step 912). The profile identification can be a composite key or a unique name. In either case, the profile will have a composite key uniquely associated with it. The process terminates thereafter.

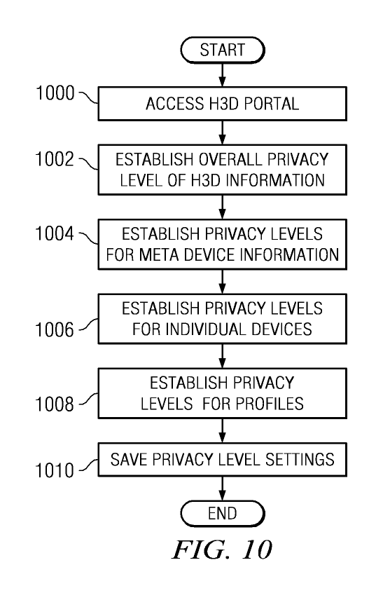

FIG. 10 is a flowchart illustrating a process of establishing privacy levels for profiles, in accordance with an illustrative embodiment of the present invention. The process shown in FIG. 10 can be implemented in a data processing system, such as server 104 or server 106, or client 110, client 112, or client 114 in FIG. 1, or data processing system 200 shown in FIG. 2. The process shown in FIG. 10 can be implemented using the methods and devices described with respect to FIG. 4 and FIG. 5. The process shown in FIG. 10 can be implemented using a household digital description definition framework.

The process begins as the user accesses the H3D portal (step 1000). An overall privacy level of H3D information is established (step 1002). The privacy level for meta-device information is then established (step 1004). Meta device information is information such as manufacturer identification, product serial number, date of purchase, date of warranty expiration, dimensions, brand name, etc. Thus, for example, privacy levels can be established based on model numbers in addition to device types or other criteria.

The household digital description definition framework then establishes privacy levels for individual devices (step 1006). Thus, for example, a television associated with a parent in the household could receive a different privacy level than a television associated with a child in the household. The household digital description definition framework then establishes privacy levels for profiles (step 1008). As described above, different profiles can have different privacy levels. The household digital description definition framework then saves the privacy level settings (step 1010). The process terminates thereafter.

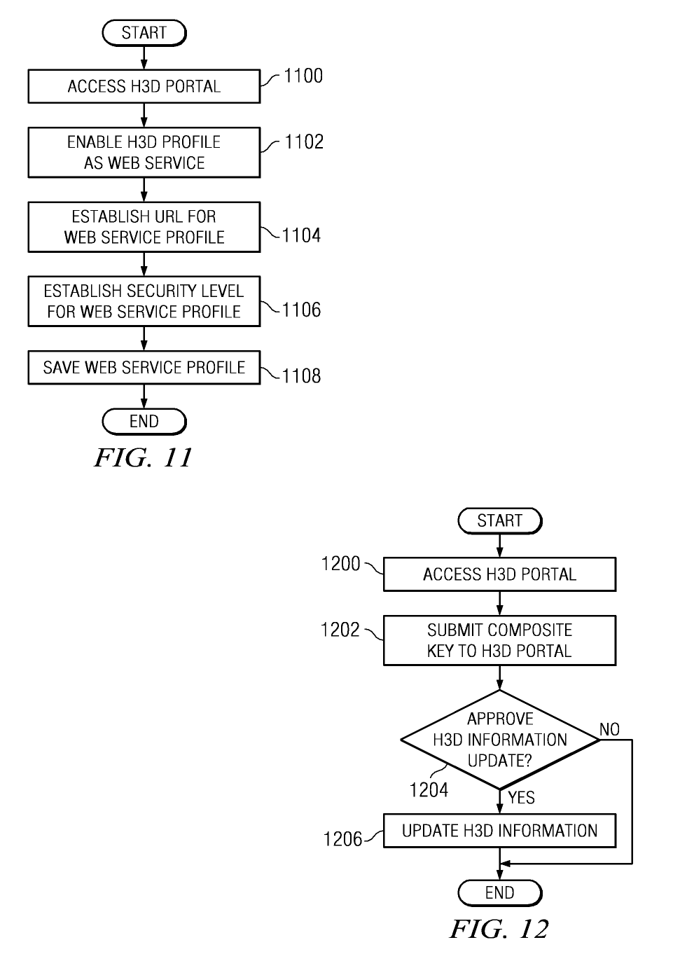

FIG. 11 is a flowchart of a process for establishing a security level for a Web service profile, in accordance with an illustrative embodiment of the present invention. The process shown in FIG. 11 can be implemented in a data processing system, such as server 104 or server 106, or client 110, client 112, or client 114 in FIG. 1, or data processing system 200 shown in FIG. 2. The process shown in FIG. 11 can be implemented using the methods and devices described with respect to FIG. 4 and FIG. 5. The process shown in FIG. 11 can be implemented using a household digital description definition framework.

The process begins as the user accesses the H3D portal (step 1100). The household digital description definition framework then enables an H3D profile as a Web service (step 1102). A Web service is a software program operated by a server or other computing device, such as a client machine like a desktop computer, laptop or other device. The Web service is accessible by a client to perform tasks. The household digital description definition framework then establishes a uniform resource link (URL) for a Web service profile (step 1104). The household digital description definition framework then establishes a security level for the Web service profile (1106). The Web service profile is then saved (step 1108). The process terminates thereafter.

FIG. 12 is a flowchart illustrating a process of updating a household digital description definition, in accordance with an illustrative embodiment of the present invention. The process shown in FIG. 12 can be implemented in a data processing system, such as server 104 or server 106, or client 110, client 112, or client 114 in FIG. 1, or data processing system 200 shown in FIG. 2. The process shown in FIG. 12 can be implemented using the methods and devices described with respect to FIG. 4 and FIG. 5. The process shown in FIG. 12 can be implemented using a household digital description definition framework.

The process begins as a merchant or other user access the H3D portal (step 1200). The merchant or other user then submits a composite key to the H3D portal (step 1202). The household digital description definition framework then determines whether to approve the H3D information update based on the information provided to it (step 1204). If an update to the H3D information is approved (a yes determination to step 1204), then the household digital description definition framework updates the H3D information (step 1206). At this point, or in a response to a no determination at step 1204, the process terminates.

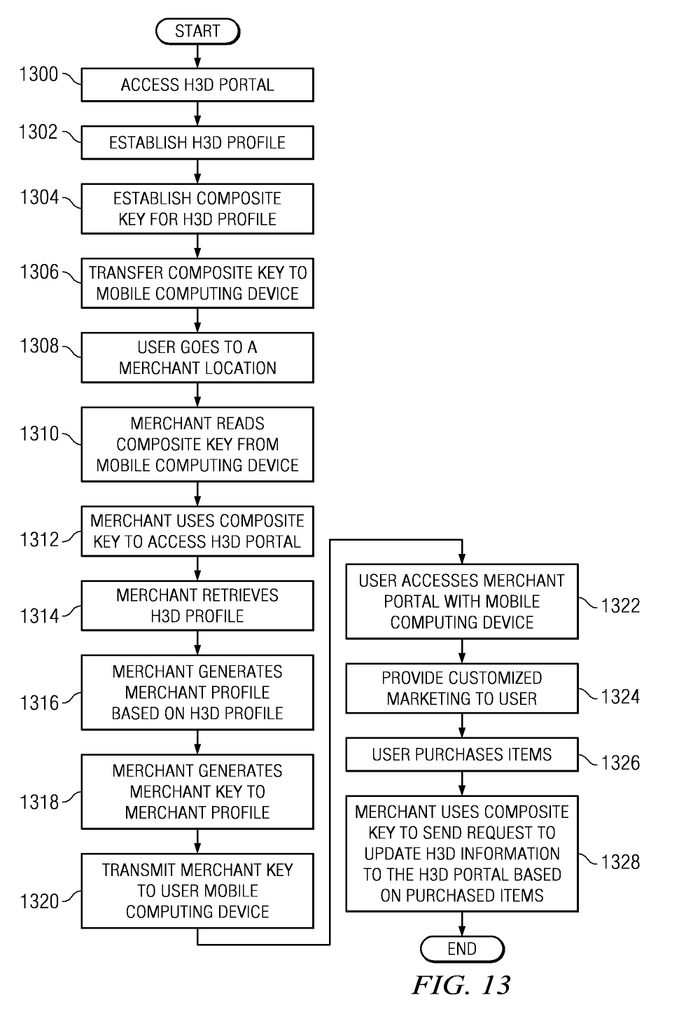

FIG. 13 is a flowchart illustrating a process of using a household digital description definition to conduct a transaction with a merchant, in accordance with an illustrative embodiment of the present invention. The process shown in FIG. 13 can be implemented in a data processing system such as server 104 or server 106, or client 110, client 112, or client 114 in FIG. 1, or data processing system 200 shown in FIG. 2. The process shown in FIG. 13 can be implemented using the methods and devices described with respect to FIG. 4 and FIG. 5. The process shown in FIG. 13 can be implemented using a household digital description definition framework.

The process begins as a user accesses an H3D portal (step 1300). The household digital description definition framework then establishes an H3D profile (step 1302). The household digital description definition then establishes a composite key for the H3D profile (step 1304). The household digital description definition framework then transfers the composite key to a mobile computing device (step 1306). At this point, a user goes to a merchant location (step 1308) with the mobile computing device. The merchant reads the composite key from the mobile computing device (step 1310). The merchant uses the composite key to access the H3D portal (step 1312). The merchant then retrieves the H3D profile (step 1314). The merchant then generates a merchant profile based on the H3D profile (step 1316). The merchant also generates a merchant key to the merchant profile (step 1318).

The merchant transmits the merchant key to the user's mobile computing device (step 1320). The user accesses the merchant portal with the mobile computing device (step 1322). The merchant then provides customized marketing information to the user (step 1324). The user then purchases items (step 1326). Finally, the merchant uses the composite key to send a request to update the H3D information via the H3D portal, based on the items purchased (step 1328). The process terminates thereafter.

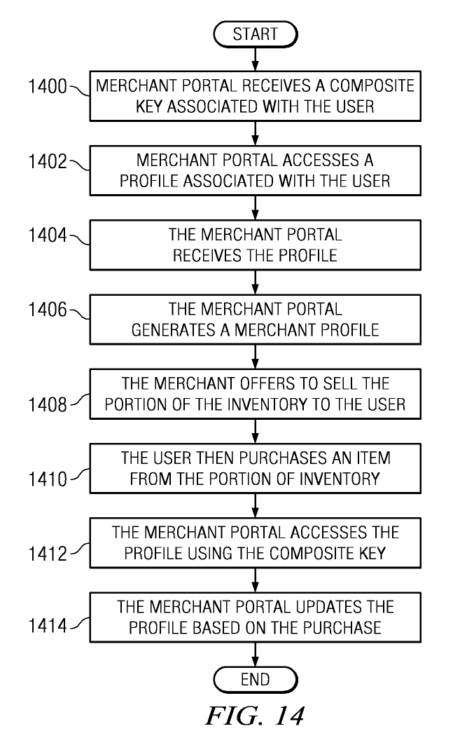

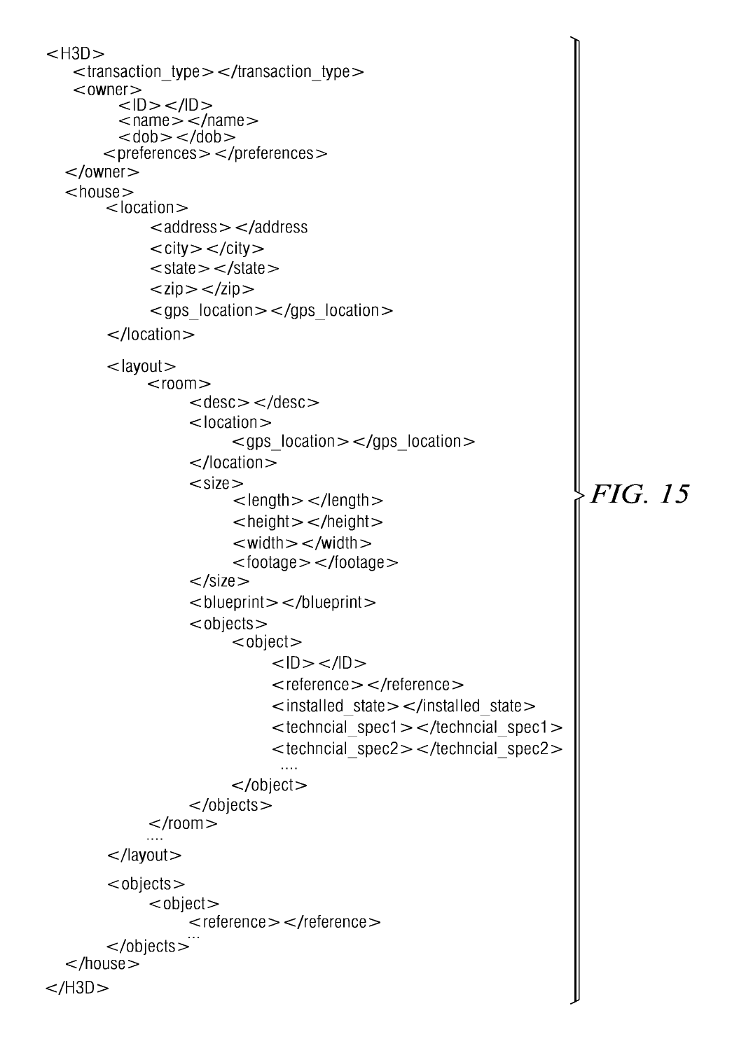

FIG. 14 is a flowchart of a process for conducting a transaction between a merchant and a user using a profile of a household digital description definition, in accordance with an illustrative embodiment of the present invention. The process shown in FIG. 14 can be implemented in a data processing system, such as server 104 or server 106, or client 110, client 112, or client 114 in FIG. 1, or data processing system 200 shown in FIG. 2. The process shown in FIG. 14 can be implemented using the methods and devices described with respect to FIG. 4 and FIG. 5. The process shown in FIG. 14 can be implemented in a merchant portal or server used by or owned by the merchant.

The process begins as the merchant portal receives a composite key associated with the user (step 1400). The merchant portal then accesses, using the composite key, a profile associated with the user, wherein the profile comprises data specifying the set of household items associated with the user (step 1402). The merchant portal then receives the profile (step 1404). The merchant portal then, responsive to receiving the profile, generates a merchant profile, wherein the merchant profile comprises data specifying a portion of inventory associated with the merchant, wherein the portion of inventory is selected based on the profile (step 1406). The merchant then offers to sell the portion of the inventory to the user (step 1408).

The user then purchases an item from the portion of inventory, wherein the purchase is formed (step 1410). The merchant portal accesses, for a second time, the profile using the composite key (step 1412). The merchant portal updates the profile based on the purchase (step 1414). The process terminates thereafter.

In an illustrative embodiment, the profile can be one of a set of profiles that make up an H3D definition, wherein the H3D definition comprises data describing a plurality of household items associated with the user. In another illustrative embodiment, the portion of inventory can be items missing from the profile. In another illustrative embodiment, the portion of inventory can be replacement items that can be used to replace existing items in the profile.

In another illustrative embodiment, the merchant portal can change the price of an item in the portion of inventory, wherein an amount of change in price is based on the profile. For example, if the profile indicates that a user would benefit from a particular device but the demographics of the user indicates that the price might be too high for the user, the price could be lowered for that particular user. Similarly, the merchant portal can offer the user a combination of items from the portion of inventory, wherein the combination is selected based on the profile.

In another illustrative embodiment, after generating the merchant profile, the merchant profile can be transmitted to a mobile computing device associated with the user. In this case, the user selects an item for purchase from the portion of inventory, whereby a selection is formed. The selection takes place at a place of business of the merchant. The selection is entered into the mobile computing device. A modified profile is then transmitted from the mobile computing device and received at the merchant portal. The modified profile is based on the selection. Then, responsive to receiving the modified profile, a second merchant profile is generated, wherein the second merchant profile comprises data specifying a second portion of inventory associated with the merchant, wherein the second portion of inventory is based on the modified profile. The merchant portal then offers to sell the second portion of inventory to the user.

In another illustrative embodiment, the profile can further include services desired by the user, not just physical products. In an illustrative embodiment the profile can further comprise a level of information regarding the set of household items, wherein the level of information determines what information the profile contains. The profile can further comprise security information, wherein the security information determines the level of access the merchant has to the H3D definition.

In another illustrative embodiment, responsive to receiving the profile, a merchant key is generated. The merchant key comprises a code usable by the user to access merchant Web services, wherein the merchant maintains on the Web services data representing at least the portion of inventory. The merchant key is then transmitted to the user. The user is then permitted access to merchant Web services using the merchant key. The merchant Web services are configured for the user based on the profile. Thus, the Web services, at least as perceived by the user, are specifically tailored to the user's needs and desires.

Although the illustrative embodiments of the present invention have been presented in the context of a user making purchases at a physical location of a merchant, the illustrative embodiments of the present invention can also be used with respect to online stores. The illustrative embodiments of the present invention are particularly well suited to online stores and online shopping, because the exchange of objects, such as those shown in FIG. 4, can be performed automatically as the user is shopping online. If preferred, a user can be given control over whether to allow certain objects to be received or accepted with respect to the household digital description definition framework. For example, a profile can still be generated by the user, and a user can determine when to allow a transaction object to be merged with a household definition object. Alternatively, a profile can be generated automatically in response to a merchant suggest object. Thus, the illustrative embodiments of the present invention can provide for enhanced online shopping.

In another illustrative embodiment of the present invention, a user can have a hybrid experience between the virtual world and the real world. In this case, a user is engaged in a virtual world through an avatar. The avatar can enter into a virtual representation of a store of a merchant. Through the avatar, the user can engage the merchant in a series of transactions via the use of profiles and objects, as described with respect to the household digital description definition framework 400, as shown in FIG. 4. For example, the avatar can engage in activities as if the avatar were a real user in a real store, as described in FIG. 4. The resulting transactions can be translated into real-life purchases. Alternatively, the transactions can be associated only with the virtual world, or a combination of both real life purchases and virtual purchases.

The illustrative embodiments can also be represented in a recordable type medium that stores a household digital description definition. Such a definition includes first data representing a household definition object, wherein the household definition object comprises corresponding sets of information corresponding to ones of household items associated with the user. The household digital description definition can also include data representing a set of profiles. The corresponding sets of information are grouped into ones of the sets of profiles, wherein ones of profiles comprise different levels of information regarding corresponding household items in the corresponding sets of profiles, and wherein ones of profiles comprise differing levels of security. The household digital description definition also includes third data representing an overall security setting. The overall security setting determines access to the household definition object.

The recordable type medium can also include instructions for generating the household definition object. Generating can be performed by scanning for at least one of first signals generated by wireless devices, second signals generated by radio frequency identification tags, third signals generated by broadband over power lines, fourth signals generated by an Internet connection, and combinations thereof.

Thus, the illustrative embodiments provide for a household digital description definition framework which enables an electronic description of a consumer's household in an architected distribution of selected information contained in the household digital description definition. The contents of the household digital description definition can be distributed in a markup language format, such as an extensible markup language (XML) format, as shown with respect to FIG. 15.

FIG. 15 shows exemplary pseudo code for defining a household digital description definition, in accordance with an illustrative embodiment of the present invention. The pseudo code shown in FIG. 15 can be implemented in a data processing system such as server 104, server 106 or client 110, client 112, or client 114 in FIG. 1, or data processing system 200 shown in FIG. 2. The pseudo code shown in FIG. 15 can be used to implement a household digital description definition.

Thus, the illustrative embodiments provide for a computer implemented method for conducting a transaction between a merchant and a user. Using a composite key generated by a user, a user profile associated with the user and generated by the user is accessed. Accessing is performed by a merchant. The user profile comprises data specifying a set of household items owned by the user. The user profile is one of a set of user profiles that make up a H3D definition, wherein the H3D definition comprises data describing a plurality of household items belonging to the user, and wherein the plurality of household items includes the set of household items. Responsive to accessing the user profile, a merchant profile is generated. The merchant profile comprises data specifying a portion of inventory associated with the merchant, wherein the portion of inventory is selected based on the user profile. An offer to sell the portion of inventory is transmitted, preferably to the user.

In another illustrative embodiment, the portion of inventory comprises items missing from the user profile. Additionally, the portion of inventory can comprise replacement items that can be used to replace existing items in the user profile.

In another illustrative embodiment, the method includes the user purchasing an item from the portion of inventory, wherein a purchase is formed. For a second time the user profile is accessed using the composite key. The user profile is updated based on the purchase.

In another illustrative embodiment, the method includes changing a price of an item in the portion of inventory, wherein an amount of change in price is based on the user profile. In yet another illustrative embodiment, the method includes offering the user a combination of items from the portion of inventory, wherein the combination is selected based on the user profile.

In still another illustrative embodiment, the method includes after generating the merchant profile, transmitting the merchant profile to a mobile computing device associated with the user. In this case, the user can select an item for purchase from the portion of inventory, whereby a selection is formed, wherein the selection takes place at a place of business of the merchant, and wherein the selection is entered into the mobile computing device. A modified profile based is received from the mobile computing device on the selection responsive to receiving the modified profile, a second merchant profile is generated. The second merchant profile comprises data specifying a second portion of inventory associated with the merchant. The second portion of inventory is selected based on the modified profile. The second portion of inventory is offered for sale to the user.

Still further, this illustrative embodiment can further include changing a price of an item in the second portion of inventory, wherein an amount of change in price is based on the modified profile. The user is offered a combination of items from the portion of inventory, wherein the combination is selected based on the modified profile.

In another illustrative embodiment, the user profile further comprises services desired by the user. In another illustrative embodiment, the user profile further comprises a level of information regarding the set of household items, wherein the level of information determines what information the user profile contains.

In still another illustrative embodiment, the user profile further comprises security information, wherein the security information determines a level of access the merchant has to the H3D definition. In yet another illustrative embodiment, the method includes, responsive to receiving the user profile, generating a merchant key, wherein the merchant key comprises a code usable by the user to access a merchant Web services, wherein the merchant maintains on the Web services data representing at least the portion of inventory. The merchant key is transmitted to the user. The user is permitted access to the merchant Web services, wherein the merchant Web services are configured for the user based on the user profile.

In another illustrative embodiment, the set of household items comprises at least one of a television, a video cassette recorder, a digital video recorder, a radio, a stereo, a refrigerator, a washing machine, a dryer, a dishwasher, a mobile phone, a camera, a toaster, a wireless picture frame, a clock, an article of furniture, an article kitchen equipment, a book, a telephone, food items, an article of clothing, a switch, a lamp, a water heater, an air conditioner, a heater, a fireplace, a pet, and combinations thereof.

The illustrative embodiments also provide for a recordable type medium storing a household digital description definition. The household digital description definition comprises: first data representing a household definition object, wherein the household definition object comprises corresponding sets of information corresponding to ones of household items associated with a user; second data representing a set of profiles, wherein the corresponding sets of information are grouped into ones of the set of profiles, wherein ones of profiles comprise differing levels of information regarding corresponding household items in the corresponding sets of profiles, and wherein ones of profiles comprise differing levels of security; and third data representing an overall security setting, wherein the overall security setting determines access to the household definition object.

In a further illustrative embodiment, this recordable-type medium can also include instructions for generating the household definition object by scanning for at least one of first signals generated by wireless devices, second signals generated by radio frequency identification tags, third signals generated by broad band over power lines, fourth signals generated via an Internet connection, and combinations thereof.

Embodiments of the present invention may be implemented entirely in hardware, entirely in software or using a combination of both hardware and software elements. In one embodiment, the invention is implemented in software, including but not being limited to firmware, resident software, microcode, or the like.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD-read/write (DVD-R/W), high definition DVD (HDDVD) and blu-ray DVD.

A data processing system suitable for storing and/or executing program code will include at least one processor coupled directly or indirectly to memory elements through a communication medium (e.g., a system bus). The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention embodiments in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for conducting a transaction between a merchant and a user, the computer-implemented method comprising:
accessing, using a composite key generated by a user, a user profile associated with the user and generated by the user, wherein accessing is performed by a merchant, wherein the user profile comprises data specifying a set of household items owned by the user, wherein the user profile is one of a set of user profiles that make up a H3D definition, wherein the H3D definition comprises data describing a plurality of household items belonging to the user, and wherein the plurality of household items includes the set of household items;
responsive to accessing the user profile, generating a merchant profile, wherein the merchant profile comprises data specifying a portion of inventory associated with the merchant, wherein the portion of inventory is selected based on the user profile; and
transmitting an offer to sell the portion of inventory.

2. The computer-implemented method of claim 1 wherein the portion of inventory comprises items missing from the user profile.

3. The computer-implemented method of claim 1 wherein the portion of inventory comprises replacement items that can be used to replace existing items in the user profile.

4. The computer-implemented method of claim 1 further comprising:
the user purchasing an item from the portion of inventory, wherein a purchase is formed;
accessing for a second time the user profile using the composite key; and updating the user profile based on the purchase.

5. The computer-implemented method of claim 1 further comprising:
changing a price of an item in the portion of inventory, wherein an amount of change in price is based on the user profile.

6. The computer-implemented method of claim 1 further comprising:
offering the user a combination of items from the portion of inventory, wherein the combination is selected based on the user profile.

7. The computer-implemented method of claim 1 further comprising:
after generating the merchant profile, transmitting the merchant profile to a mobile computing device associated with the user.

8. The computer-implemented method of claim 7 further comprising:
the user selecting an item for purchase from the portion of inventory, whereby a selection is formed, wherein the selection takes place at a place of business of the merchant, and wherein the selection is entered into the mobile computing device;
receiving from the mobile computing device a modified profile based on the selection;
responsive to receiving the modified profile, generating a second merchant profile, wherein the second merchant profile comprises data specifying a second portion of inventory associated with the merchant, wherein the second portion of inventory is selected based on the modified profile; and
offering to sell the second portion of inventory to the user.

9. The computer-implemented method of claim 8 further comprising:
changing a price of an item in the second portion of inventory, wherein an amount of change in price is based on the modified profile; and
offering the user a combination of items from the portion of inventory, wherein the combination is selected based on the modified profile.

10. The computer-implemented method of claim 1 wherein the user profile further comprises services desired by the user.

11. The computer-implemented method of claim 1 wherein the user profile further comprises a level of information regarding the set of household items, wherein the level of information determines what information the user profile contains.

12. The computer-implemented method of claim 1 wherein the user profile further comprises security information, wherein the security information determines a level of access the merchant has to the H3D definition.

13. The computer-implemented method of claim 1 further comprising:
responsive to receiving the user profile, generating a merchant key, wherein the merchant key comprises a code usable by the user to access a merchant Web services, wherein the merchant maintains on the Web services data representing at least the portion of inventory;
transmitting the merchant key to the user; and
permitting the user access to the merchant Web services, wherein the merchant Web services are configured for the user based on the user profile.

14. The computer-implemented method of claim 1 wherein the set of household items comprises at least one of a television, a video cassette recorder, a digital video recorder, a radio, a stereo, a refrigerator, a washing machine, a dryer, a dishwasher, a mobile phone, a camera, a toaster, a wireless picture frame, a clock, an article of furniture, an article kitchen equipment, a book, a telephone, food items, an article of clothing, a switch, a lamp, a water heater, an air conditioner, a heater, a fireplace, a pet, and combinations thereof.

15. A recordable type medium storing a computer program product for conducting a transaction between a merchant and a user, the computer program product comprising:
instructions for accessing, using a composite key generated by a user, a user profile associated with the user and generated by the user, wherein accessing is performed by a merchant, wherein the user profile comprises data specifying a set of household items owned by the user, wherein the user profile is one of a set of user profiles that make up a H3D definition, wherein the H3D definition comprises data describing a plurality of household items belonging to the user, and wherein the plurality of household items includes the set of household items;
instructions for responsive to accessing the user profile, generating a merchant profile, wherein the merchant profile comprises data specifying a portion of inventory associated with the merchant, wherein the portion of inventory is selected based on the user profile; and
instructions for transmitting an offer to sell the portion of inventory.

16. The recordable type medium of claim 15 wherein the computer program product further comprises:
instructions for the user purchasing an item from the portion of inventory, wherein a purchase is formed;
instructions for accessing for a second time the user profile using the composite key; and
instructions for updating the user profile based on the purchase.

17. The recordable type medium of claim 15 wherein the computer program product further comprises:
instructions for changing a price of an item in the portion of inventory, wherein an amount of change in price is based on the user profile; and
instructions for offering the user a combination of items from the portion of inventory, wherein the combination is selected based on the user profile.

18. A recordable type medium storing a household digital description definition, wherein the household digital description definition comprises:
first data representing a household definition object, wherein the household definition object comprises corresponding sets of information corresponding to ones of household items associated with a user;
second data representing a set of profiles, wherein the corresponding sets of information are grouped into ones of the set of profiles, wherein ones of profiles comprise differing levels of information regarding corresponding household items in the corresponding sets of profiles, and wherein ones of profiles comprise differing levels of security; and
third data representing an overall security setting, wherein the overall security setting determines access to the household definition object.

19. The recordable type medium of claim 18 further comprising:
instructions for generating the household definition object by scanning for at least one of first signals generated by wireless devices, second signals generated by radio frequency identification tags, third signals generated by broad band over power lines, fourth signals generated via an Internet connection, and combinations thereof.
